(19) United States
(12) Patent Application Publication
(10) Pub. No.: US 2003/0161241 A1
(43) Pub. Date: Aug. 28, 2003

(54) Loading device of compact disk player for automobile

(75) Inventors: Hyun-Chan Park, Yongin-si (KR); Soon-Yong Shin, Suwon-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/145,879

(22) Filed: May 16, 2002

(30) Foreign Application Priority Data
Feb. 25, 2002 (KR) 2002-9975

(51) Int. Cl. G11B 33/02

(52) U.S. Cl. 369/77.1

(57) ABSTRACT

A loading device of a compact disk player for an automobile is disclosed. The loading device has a roller provided at an inlet to be rotated by a driving motor, a roller arm supporting the roller to be moved up and down, the roller arm being divided into a first roller arm and a second roller arm which are connected to a connecting shaft to be in the same plane and separately rotated about the connecting shaft by a certain angle, and a spring interposed between the roller arm and a player body to bias the roller upwardly by its restoring force, whereby a disk inserted through the inlet is loaded into the player body and seated on a turntable. The loading device of the present invention has constant ejecting force, thereby preventing ejecting errors and thus improving performance and reliability of products.

### BACKGROUND OF THE INVENTION

1. Field of the Invention

The present invention relates to a compact disk player for an automobile, and more particularly to a loading device of a compact disk player for an automobile, which includes two divided roller arms adapted to be operated separately from each other to minimize errors generated when a disk is loaded into the compact disk player.

2. Description of the Prior Art

In general, a compact disk player for an automobile is an appliance for playing back data recorded on a compact disk by an optical system.

Such a compact disk player for an automobile comprises a turntable on which a disk is placed, a loading unit for pulling in a disk inserted into an insertion slot and seating the disk on the turntable, a drive for rotating the turntable, a clamping unit for preventing shifting of the disk during rotation of the turntable, an optical pick up for writing data on a disk and reading data from the disk while radially moving on the disk, and a transfer device for moving an optical pick up back and forth.

FIGS. 1 and 2 show a conventional loading device of a compact disk player for an automobile.

As shown in the drawings, such a loading device of a compact disk player for an automobile is comprised of a roller 40 for retracting a disk “D” into a player body by its frictional force, and a roller arm 50 for supporting the roller 40 to be moved up and down, and is installed at an inlet of the player body 10.

The player body 10 is divided into an upper frame assembly 30 and a lower frame assembly 20. By assembling of the upper and the lower frame assemblies 30 and 20, the inlet 12 is formed at the front of the player body. A driving motor 22 is mounted at a side of the inlet 12. A shaft 22a of the driving motor 22 is extended toward a side of the player body 10. The shaft 22a is joined at its end to a driving gear 24.

The lower frame assembly 20 is formed at front portions of its both sides with supporting cuts 26 in which the opposite ends of the roller arm 50 are inserted and rotatably supported. The both sides of the lower frame assembly 20 are also provided at locations rearwardly spaced from the supporting cuts 26 with long cuts 28 in which the opposite ends of the roller 40 are rotatably supported. Each of the long cuts 28 is shaped into a segment of a circle having a center at the supporting cuts 26.

The roller 40 is reduced in diameter toward its center from its opposite ends such that a disk “D” inserted through the inlet 12 of the player body 10 is automatically positioned at the center of the roller 40. The roller 40 has an axial hole into which a roller shaft 42 is removably inserted.

The opposite ends of the roller shaft 42 are inserted into the long cuts 28 of the player body 10 and rotatably supported thereby. Bushes 44 are coupled to the opposite ends of the roller shaft 42. The roller shaft 42 with the bushes coupled to its opposite ends is supported by the long cuts 28 of the player body 10 to prevent generation of noise during rotation of the roller shaft 42. A follower gear 46 is coupled to an end of the roller shaft 42 and rotated therewith.

The roller arm 50 assumes a plate shape, and is provided at its both ends with pins 52 which are inserted into the supporting cuts 26 of the player body 10. One of the both pins 52 is more extended outwardly than the other pin and is provided with an intermediate gear 60 coupled thereto. The intermediate gear 60 has two gear parts. The first gear part 62 of the intermediate gear 60 is engaged with the driving gear 24 of the driving motor 22, and the second gear part 64 is engaged with the follower gear 46 of the roller shaft 42. The intermediate gear 60 is provided at its outer side with a pulley 66 for transmitting turning force of the driving motor 22 to a clamping device.

The roller arm 50 is provided at its front edge with a pair of protrusions 54 with a certain spacing therebetween for preventing two or more disks from being inserted into the player body. The pair of protrusions 54 is covered with rubber protectors 55. The roller arm 50 is provided at its both ends with spring cuts 56, and the player body 10 is provided with spring holes 29 at its both sides corresponding to the spring cuts 56. Springs 70 are interposed between the spring cuts 56 and the spring holes 29.

The roller arm 50 is provided at its both rear sides with retaining pieces 58, which are extended rearwardly. Each of the retaining pieces 58 is formed with a retaining cut 58a into which the bush 44 coupled to the roller shaft 42 is inserted so that the roller 40 is operated together with the roller arm 50.

In other words, when a disk “D” is loaded into the player body, the roller 40 is lowered along the long cuts 28 of the player body 10 by a distance corresponding to a thickness of the disk “D”, and thus the roller arm 50 coupled to the roller by the retaining pieces 58 is rotated downwardly about the spring cuts 56 by the lowering distance of the roller 40.

When a disk is seated on a turntable 1 or ejected outward, the roller 40 is raised upwardly by restoring force of the springs 70 connected to the both ends of the roller arm 50.

In such a conventional loading device, when the motor shaft 22a of the driving motor 22 is rotated, the turning force of the driving motor is transmitted to the intermediate gear 60 via the driving gear 24. Subsequently, the turning force of the intermediate gear 60 is transmitted to the follower gear 46, so that the follower gear 46 is rotated and thus the roller is also rotated. That is, when the driving motor 22 is normally rotated, the roller 40 is rotated in a direction of loading a disk into the player body 10, and, when the driving motor 22 is reversely rotated, the roller is rotated in a direction of ejecting a disk.

However, since the conventional loading device of a compact disk player for an automobile includes a roller arm 50 which is constructed of a single component, when the roller arm 50 is deformed or portions of the upper and lower frame assemblies 30 and 20 are deformed, the roller 40 cannot be positioned in parallel to the upper frame assembly 30. Accordingly, since the roller 40 cannot come into contact with a disk in the parallel position during loading of a disk, errors occur when a disk is loaded and ejected.

In other words, if the roller 40 is not positioned parallel to the upper frame assembly 30, since the roller 40 comes into contact with a part of a disk “D” and the symmetrical portion of the roller 40 does not come into contact with the disk “D”, the disk cannot be smoothly loaded into the player body 10 and is rotated in place, thereby causing ejection error.

Furthermore, if a disk does not come into contact with the roller 40 in the parallel position, since ejecting force is not sufficient, there occurs a inferiority, lowering performance and reliability.

### SUMMARY OF THE INVENTION

Accordingly, the present invention has been made keeping in mind the above problems occurring in the prior art, and an object of the present invention is to provide a loading device of a compact disk player for an automobile which is intended to prevent generation of ejecting errors by including a roller in contact with a disk in a parallel position even though an upper frame assembly or a lower frame assembly has a deformation at portions to which a roller arm is installed.

In order to accomplish the above object, the present invention provides a loading device of a compact disk player for an automobile comprising: a roller provided at an inlet to be rotated by a driving motor; a roller arm supporting the roller to be moved up and down, the roller arm being divided into a first roller arm and a second roller arm which are connected to a connecting shaft to be in the same plane and separately rotated about the connecting shaft by a certain angle; and a spring interposed between the roller arm and a player body to bias the roller upwardly by its restoring force; whereby a disk inserted through the inlet is loaded into the player body and seated on a turntable.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a conventional loading device of a compact disk player for an automobile;

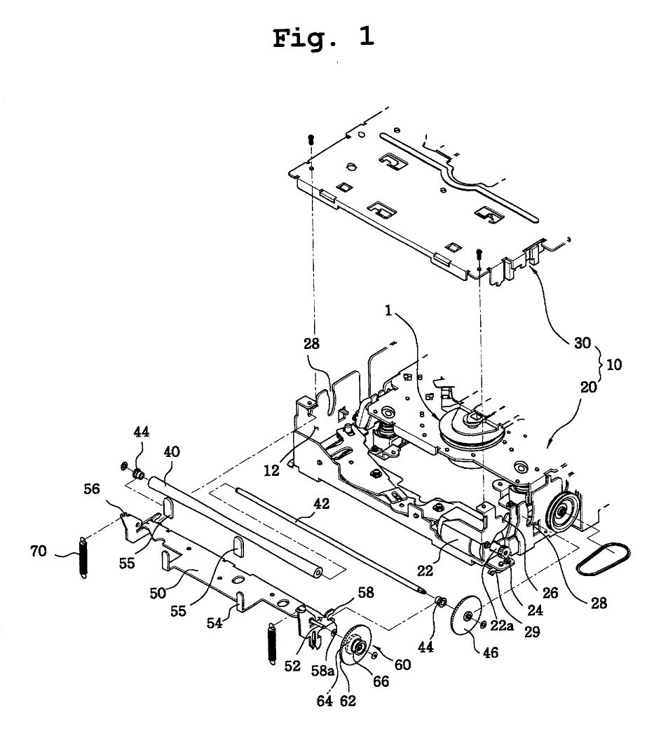

FIG. 2 is a perspective view of a conventional loading device mounted on a lower frame assembly of a compact disk player for an automobile in which an upper frame assembly is removed therefrom;

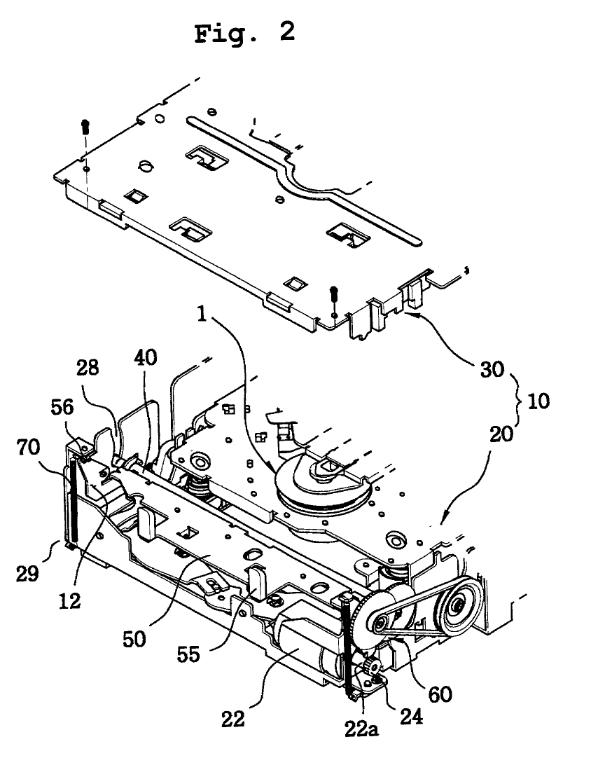

FIG. 3 is an exploded perspective view of a loading device of a compact disk player for an automobile according to the present invention;

FIG. 4 is a perspective view of the loading device according to the present invention mounted on a lower frame assembly of a compact disk player for an automobile in which an upper frame assembly is removed therefrom;

FIG. 5 is a plan view of a compact disk player to which the loading device according to the present invention is applied;

FIG. 6 is a front view of the loading device according to the present invention which shows its operation.

### DETAILED DESCRIPTION OF THE INVENTION

This invention will be described in further detail by way of example with reference to the accompanying drawings.

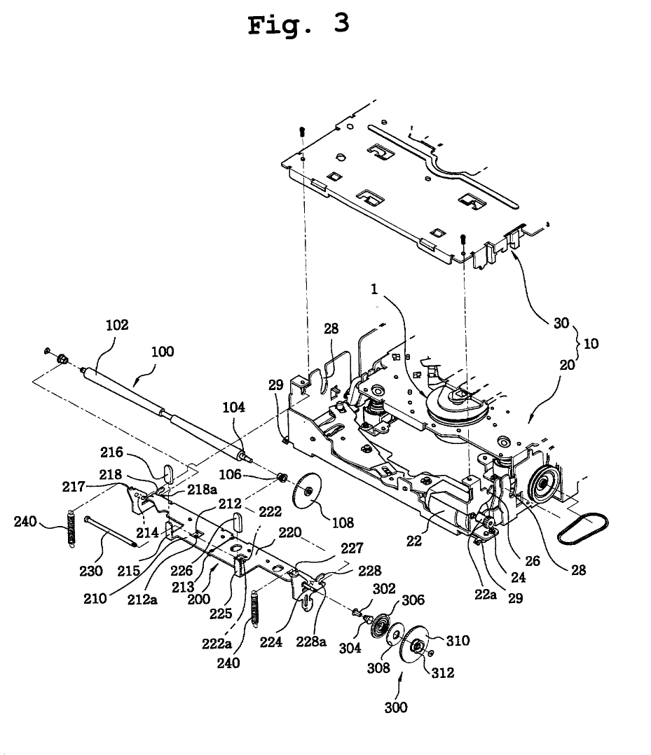

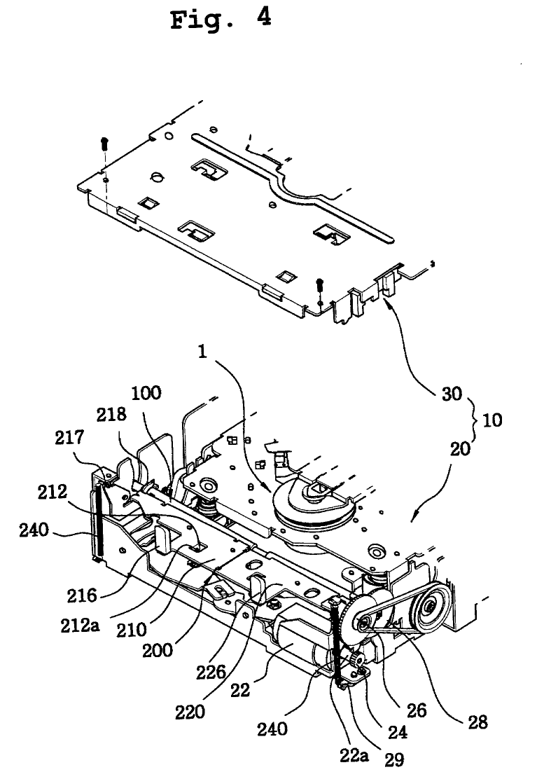

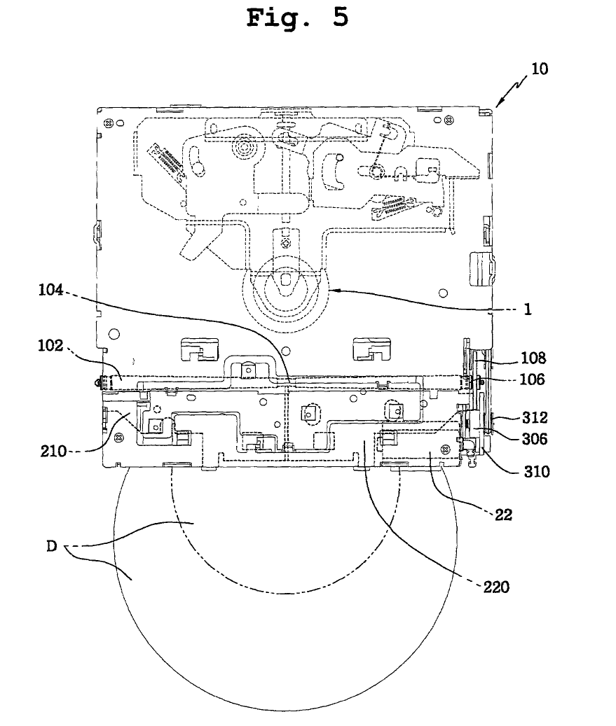

As shown in FIGS. 3 to 5, a loading device of a compact disk player for an automobile according to the present invention is intended to load a disk “D” inserted through an inlet 12 of a player body 10 and seat the disk “D” on a turntable 1 provided in the player body 1, and comprises a roller 100 for retracting a disk into the player body 10 by its frictional force, a roller arm 200 for supporting the roller to be moved up and down, and springs 240 for elastic supporting of the roller arm.

The player body 10 comprises an upper frame assembly 30 and a lower frame assembly 20. By assembling of the upper and the lower frame assemblies 30 and 20, the inlet 12 is formed at the front of the player body. The player body 10 is provided inside the inlet 12 with a sensor for detecting a disk loaded through the inlet and transmitting an electrical signal, and a driving motor 22 mounted on the lower frame assembly 20 and adapted to operate by the signal from the sensor.

A shaft 22a of the driving motor 22 passes through the lower frame assembly 20 and is extended outwardly, and a driving gear 24 is joined to an end of the motor shaft 22a.

The lower frame assembly 20 is formed at front portions of its both sides with supporting cuts 26 in which the opposite ends of a roller arm 200 are inserted and rotatably supported. The both sides of the lower frame assembly 20 are also provided at locations rearwardly spaced from the supporting cuts 26 with long cuts 28 in which the opposite ends of the roller 100 are rotatably supported. Each of the long cuts 28 is shaped as a segment of a circle having a center at the supporting cuts 26.

The roller 100 is comprised of a pair of roller rubbers 102 and a roller shaft 104 which are manufactured by extrusion molding. The opposite ends of the roller shaft 104 are rotatably supported in the long cuts 28 of the player body 10.

Each of the roller rubbers 102 is reduced in diameter toward its center from its outer end such that a disk “D” inserted through the inlet 12 of the player body 10 is automatically positioned at the center of the roller.

Bushes 106 are coupled to the opposite ends of the roller shaft 104. The roller shaft 104 with the bushes coupled to its opposite ends is supported by the long cuts 28 of the player body 10 to prevent generation of noise during rotation of the roller shaft 104. A follower gear 108 is coupled to an end of the roller shaft 104 and rotated therewith.

The roller arm 200 is formed into a plate shape. The roller arm 200 is divided into a left roller arm 210 and a right roller arm 220, which are connected in the same plane by a connecting shaft 230 and are adapted to be rotated about the connecting pin 230 by a certain angle.

The left and right roller arms 210 and 220 are provided at their lower surfaces with connecting pieces 212, 222, which are symmetrically arranged. The connecting pieces 212, 222 are centrally formed with connecting holes 212a and 222a into which the connecting shaft 230 is inserted. The left and right roller arms 210 and 220 are rotatably supported by the connecting shaft 230.

The left roller arm 210 is provided at front and rear ends of its lower surface with stoppers 213 which extended toward the right roller arm 220 with a predetermined gap between the stopper 213 and the roller arm 220, and each roller arm 200 is rotated about a connecting shaft 230 by a predetermined gap.

The roller arm 200, which is divided into two segments connected to each other by the connecting shaft 230, is provided at its both ends with pins 214 and 224 which are inserted into the supporting cuts 26 of the player body 10. The right one of the both pins 224 is more outwardly extended than the left pin and is provided with a clutch 300 joined to its end.

The clutch 300 comprises a stopper 302 joined to the pin 224 of the right roller arm 220, a spring 304 coupled to the stopper and supported by the stopper, a clutch gear 306, a felt 308 and an intermediate gear 310.

The intermediate gear 310 is engaged with the driving gear 24 of the driving motor 22, and the clutch gear 306 is engaged with the follower gear 108 of the roller shaft 104. The felt 308 is interposed between the intermediate 310 and the clutch gear 306 and serves to transmit turning force of the intermediate gear 310 to the clutch gear 306. The spring 304 functions to press the clutch gear 306 toward the intermediate gear 310. The intermediate gear 310 is integrally formed at its outer side with a pulley 312 to transmit turning force of the driving motor 22 to a clamping device.

The left and right roller arms 210 and 220 are provided at their front edges with a pair of protrusions 215 and 225 with a certain spacing therebetween to prevent two or more disks from being inserted into the player body. The protrusions 215 and 225 are covered with rubber protectors 216 and 226. The roller arm 200 is formed at both sides of its front part with spring cuts 217 and 227, and the player body 10 is provided with spring holes 29 at its both sides corresponding to the spring cuts 217 and 227. Springs 70 are connected between the spring cuts 217 and 227 and the spring holes 29 to pull a front end of the roller arm 200.

The left and right roller arms 210 and 220 are provided at their both rear sides with retaining pieces 218 and 228 which are extended rearwardly. The retaining pieces 218 and 228 are formed with retaining cuts 218a and 228a into which the bushes 106 coupled to the roller shaft 104 are inserted so that the roller 100 is operated together with the roller arm 200.

Functions of the loading device according to the present invention will now be described.

To install the loading device according to the present invention to the player body 10 of a compact disk player for an automobile, the roller 100 is coupled at its opposite ends with bushes, and inserted into the retaining cuts 218a and 228a of the roller arm 200.

Thereafter, both the pins 214 and 224 of the roller arm 200 are inserted into the supporting cuts 26 of the lower frame assembly 20, and the opposite ends of the roller shaft 104 of the roller 100 are inserted into the long cuts 28 of the lower frame assembly 20 with the bushes 106 disposed therebetween. Accordingly, the roller 100 is operated together with the roller arm 200.

Subsequently, the springs 240 are connected between the spring cuts 217 and 227 of the roller arm 200 and spring holes 29 of the lower frame assembly 20. The clutch 300 is coupled to the pin 224 of the right roller arm 220, and the roller shaft 104 is coupled with the follower gear 108. At this point, the intermediate gear 310 of the clutch 300 is engaged with the driving gear 24 of the driving motor 22, and the follower gear 108 of the roller shaft 104 is engaged with the clutch gear 306 of the clutch 300. With this engagement of gears, turning force of the driving motor 22 is transmitted to the intermediate gear 310 and the clutch gear 306 via the driving gear 24 so that the follower gear 108 and the roller 100 are rotated. In other words, when the driving motor 22 is rotated normally, the roller 100 is rotated in a direction of loading a disk “D” into the player body 10, while when the driving motor 22 is rotated reversely, the roller 100 is rotated in a direction of ejecting a disk “D”.

After assembly of the roller 100 and the roller arm 200 is completed, the upper frame assembly 30 is coupled to the lower frame assembly 20.

When a disk “D” is inserted into the inlet 12 of the player body 10, the sensor in the player body 10 detects the disk “D” and activates the driving motor 22, so that the motor shaft 22a of the driving motor 22 is rotated normally.

Therefore, the roller 100 is rotated to load the disk “D” and transfer the disk to the turntable of the player body 10. At this point, the roller 100 is lowered along the long cuts 28 by a distance corresponding to a thickness of the disk “D”, and the roller arm 200, which is coupled to roller 100 by the retaining pieces 218 and 228, is rotated about the pins 214 and 224 by a lowered distance of the roller 100.

When the disk “D” is ejected outwardly, the driving motor 22 is rotated reversely and thus the roller 100 is rotated in a direction of ejecting the disk “D”. When the disk “D” is completely ejected, the roller arm 200 is rotated and the roller 100 is raised upwardly by restoring force of the springs 240 connected to the opposite ends of the roller arm 200.

Since the roller arm 200 supporting the roller 100 is divided into the left roller arm 210 and the right roller arm 220 and the left and right roller arms are rotatably connected to each other by the connecting shaft 230, there are no loading and ejecting errors even though the roller arm 200 itself is deformed or the upper and lower frame assemblies 30 and 20 are deformed at portions to which the roller arm 200 is coupled.

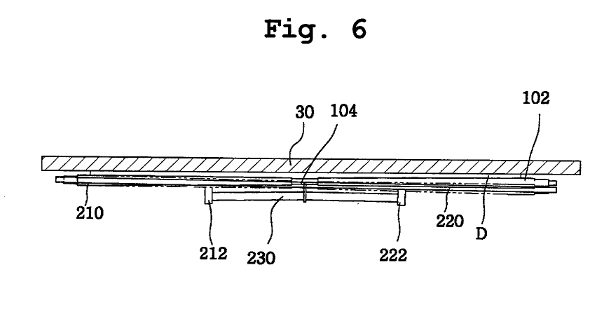

That is, even though the roller arm 200 is installed to be inclined as indicated by a phantom line of FIG. 6, since the springs 240 pull both ends of the roller arm 200, the roller arm 200 is rotated about the connecting shaft 230 by a certain angle and thus the roller 100 is adjusted to be parallel to the disk “D”, as indicated by a solid line of FIG. 6.

As such, since the roller 100 is always in contact with a disk “D” to be parallel to the disk, ejecting force is constantly maintained. Accordingly, there is no ejecting error when a disk “D” is inserted, and thus defective fraction of products is reduced and performance and reliability are enhanced.

Furthermore, since the loading device is designed to have slip in the clutch, i.e., slip between the intermediate gear 310 and the clutch gear 306 while there is no slip in the roller owing to the roller rubbers 102 and the roller shaft 104 which are integrally manufactured, a recording surface of a disk “D” is protected.

As described above, the present invention provides a loading device of a compact disk player for an automobile including a roller arm divided into two roller arm segments, which are rotated about a connecting shaft by a certain angle to enable a roller to be always in contact with a disk in a parallel position. Therefore, the loading device of the present invention has constant ejecting force, thereby preventing ejecting errors and thus improving performance and reliability of products.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A loading device of a compact disk player for an automobile comprising:
a roller provided at an inlet to be rotated by a driving motor;
a roller arm supporting the roller to be moved up and down, the roller arm being divided into a first roller arm and a second roller arm which are connected to a connecting shaft to be in the same plane and separately rotated about the connecting shaft by a certain angle; and
a spring interposed between the roller arm and a player body to bias the roller upwardly by its restoring force;
whereby a disk inserted through the inlet is loaded into the player body and seated on a turntable.

2. The loading device as set forth in claim 1, in which the first and second roller arms are provided at their lower surfaces with connecting pieces, which are symmetrically arranged, and either one of the first and second roller arms is provided at front and rear ends of its lower surface with stoppers extended toward the other roller arm with a predetermined gap between the stopper and the roller arm.

3. The loading device as set forth in claim 1, in which the roller is comprised of a roller rubber and a roller shaft which are manufactured by extrusion molding.

4. The loading device as set forth in claim 1, in which the roller arm is provided at its opposite ends with pins, and either one of both the pins is provided with a clutch, which comprises a stopper joined to the pin of the roller arm, a spring coupled to the stopper, a clutch gear, a felt and an intermediate gear, the intermediate gear being engaged with the driving gear of the driving motor, the clutch gear being engaged with the follower gear of the roller shaft, the felt being interposed between the intermediate and the clutch gear to transmit turning force of the intermediate gear to the clutch gear, the spring pressing the clutch gear toward the intermediate gear.

5. A loading device of a compact disk player for an automobile comprising:
a player body;
a roller provided at an inlet to be rotated by a driving motor;
a roller arm rotatably coupled to the player body and supporting at its rear end the roller to be moved therewith, the roller arm being divided into a first roller arm and a second roller arm which are connected to a connecting shaft to be in the same plane and separately rotated about the connecting shaft by a certain angle; and
a spring interposed between the roller arm and a player body to bias the roller upwardly by its restoring force.

6. The loading device as set forth in claim 5, in which the first and second roller arms are provided at their lower surfaces with connecting pieces, which are positioned in symmetrical manner, and either one of the first and second roller arms is provided at front and rear ends of its lower surface with stoppers extended toward the other roller arm with a predetermined gap between the stopper and the roller arm.

7. The loading device as set forth in claim 5, in which the roller is comprised of a roller rubber and a roller shaft which are manufactured by extrusion molding.

8. The loading device as set forth in claim 5, in which the roller arm is provided at its opposite ends with pins, and either one of both the pins is provided with a clutch, which comprises a stopper joined to the pin of the roller arm, a spring coupled to the stopper, a clutch gear, a felt and an intermediate gear, the intermediate gear being engaged with the driving gear of the driving motor, the clutch gear being engaged with the follower gear of the roller shaft, the felt being interposed between the intermediate and the clutch gear to transmit turning force of the intermediate gear to the clutch gear, the spring pressing the clutch gear toward the intermediate gear.
